(19) United States
(12) Patent Application Publication
(10) Pub. No.: US 2011/0253786 A1
(43) Pub. Date: Oct. 20, 2011

(54) USE OF A WIDEBAND RADIO RECEIVER WITHIN THE DEVICE TO DETECT TRANSMISSIONS FROM A PARASITIC SHIM OR OTHER UNOFFICIAL CIRCUITRY IMPLANTED WITHIN THE TERMINAL

(76) Inventors: Andrew Campbell, Canterbury (GB); Brian Docherty, Sketty (GB); James Churchman, Llysworney (GB); Kevin Maidment, Woocland (GB); Nick McGarvey, Whiteway Hill (GB)

(21) Appl. No.: 13/087,580

(22) Filed: Apr. 15, 2011

Related U.S. Application Data
(60) Provisional application No. 61/325,300, filed on Apr. 17, 2010.
(60) Provisional application No. 61/325,289, filed on Apr. 17, 2010.
(60) Provisional application No. 61/325,291, filed on Apr. 17, 2010.
(60) Provisional application No. 61/325,327, filed on Apr. 18, 2010.
(60) Provisional application No. 61/331,432, filed on May 5, 2010.

(51) Int. Cl. G06K 7/01

(52) U.S. Cl. 235/439; 340/10.1

(57) ABSTRACT

A card reader terminal is provided with circuitry to detect wireless transmission of data from the card terminal from illicit transmitting equipment within the terminal in the form of a “shim” or otherwise. The detector circuit is connected to an A/D input of a microprocessor. Voltage level at the input may be measured rather than just treating it as digital input where the voltage level would be taken by the processor as either ON (signal present) or OFF (signal not present). Where the microprocessor (or other processing electronics) used does not have an analog to digital converter input, an external analog to digital circuit may be used. The terminal can determine the level of radio signal activity in its vicinity before a card is entered into the card slot, the level after the card is inserted and the level during the time the terminal is exchanging data with the card. If there is an abrupt increase in signal level when the card is inserted or when data exchange commences, the processor can ensure that the PIN is not sent to the card and can prevent all further transactions until the radio signal is no longer present.

### CROSS-REFERENCE TO RELATED APPLICATIONS

The present application claims priority from Provisional U.S. Patent Application Ser. No. 61/325,300, filed on Apr. 17, 2010, and incorporated herein by reference.

The subject matter of the present application is also related to the following Provisional U.S. Patent Applications, all of which are incorporated herein by reference:

Ser. No. 61/325,289, filed on Apr. 17, 2010 (DAMALAK-0002P);

Ser. No. 61/325,291, filed on Apr. 17, 2010 (DAMALAK-0003P);

Ser. No. 61/325,300, filed on Apr. 17, 2010 (DAMALAK-0004P);

Ser. No. 61/325,327, filed on Apr. 18, 2010 (DAMALAK-0005P); and

Ser. No. 61/331,432, filed on May 5, 2010 (DAMALAK-0006P).

### FIELD OF THE INVENTION

The present invention relates to Point of Sale Credit Card and Payment Terminals. In particular, the present invention is directed toward improved security for Point of Sale Credit Card and Payment Terminals.

### BACKGROUND OF THE INVENTION

In a card payment terminal, serial data is exchanged between the card inserted in the reader slot of the terminal and the processing electronics within the terminal (e.g., the microprocessor). Generally, card payment terminals are designed to detect attempts to open or otherwise tamper with the terminal in an attempt intercept data exchanged between the card and the processing electronics (generally a microprocessor). Fraudsters may go to great lengths to tamper with or modify card terminal apparatus. If a terminal can be modified in such a way that signals can be intercepted and routed out of the terminal in such a way as to be invisible or at least not obvious to a user, then the chances of obtaining private data for fraudulent use are increased.

One method used is to try to insert what is known as a “shim” between the card reader terminals and the card such that data is intercepted between the card reader contacts and the card itself. Having done that, data can be extracted by leading wires out of the terminal via the card slot or otherwise. Such wires ought to be visible to a wary user. Alternatively, circuitry could be included on the shim, or elsewhere within the terminal (perhaps hidden in a battery compartment), which transmits the data wirelessly to a hidden receiver. Such a wireless shim might not be readily detected by a user.

Thus, it remains a requirement in the art to provide an improved security system for credit card and payment terminals and other sensitive electronic devices, to detect the presence of a shim and disable the card reader or notify the user that security may be compromised, when a shim is detected.

### SUMMARY OF THE INVENTION

The present invention detects wireless transmission of data from the card terminal from illicit transmitting equipment within the terminal in the form of a “shim” or otherwise. Included within the terminal electronics is a circuit designed to detect radiated signals over a wide range of frequencies. In the preferred embodiment, this circuit is based around the LTC5507 RF Power detector chip from Linear Technology that operates over the range of frequencies from 100 kHz to 1 GHz. This particular circuit design provides an analog output voltage level that depends on the strength of the detected signal. Other circuit arrangements can provide similar functionality.

In the preferred embodiment, the detector circuit is connected to an “A to D” input of the microprocessor. In this way, the voltage level at the input can be measured rather than just treating it as digital input where the voltage level would be taken by the processor as either ON (signal present) or OFF (signal not present). Where the microprocessor (or other processing electronics) used does not have an analog to digital converter input, an external analog to digital circuit may be used.

With the inclusion of this circuitry, the terminal can determine the level of radio signal activity in its vicinity before a card is entered into the card slot, the level after the card is inserted and the level during the time the terminal is exchanging data with the card. If there is an abrupt increase in signal level when the card is inserted or when data exchange commences, the processor can ensure that the PIN is not sent to the card and can prevent all further transactions until the radio signal is no longer present.

### BRIEF DESCRIPTION OF THE DRAWINGS

FIG. 1 is a diagram illustrating how the RF signal detector circuit may be used in the preferred embodiment to generate an analog signal to the input of an A/D converter input of a microprocessor.

FIG. 2 is a diagram illustrating how the RF signal detector circuit may be used in an alternative embodiment, where the microprocessor does not have an analog input and an external A/D converter is utilized.

FIG. 3 is a flowchart illustrating the steps in the RF detection process of the present invention.

FIG. 4 is a frontal view of the PayPod card terminal of the present invention.

### DETAILED DESCRIPTION OF THE INVENTION

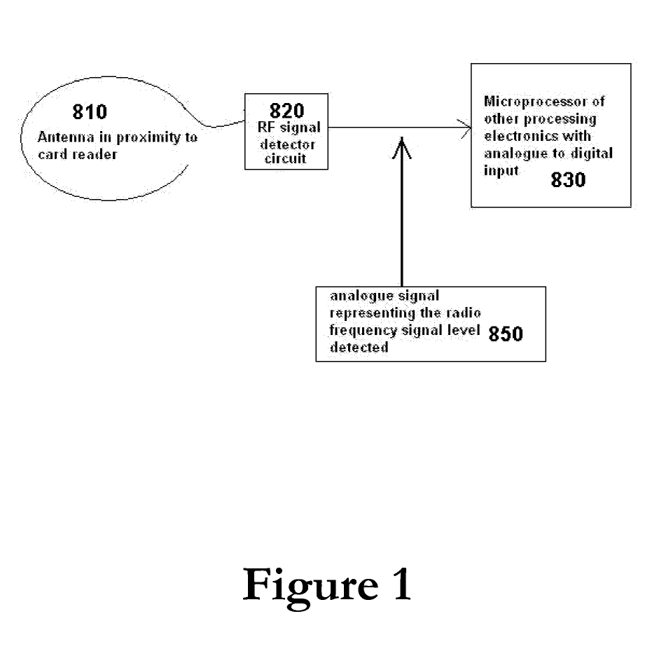

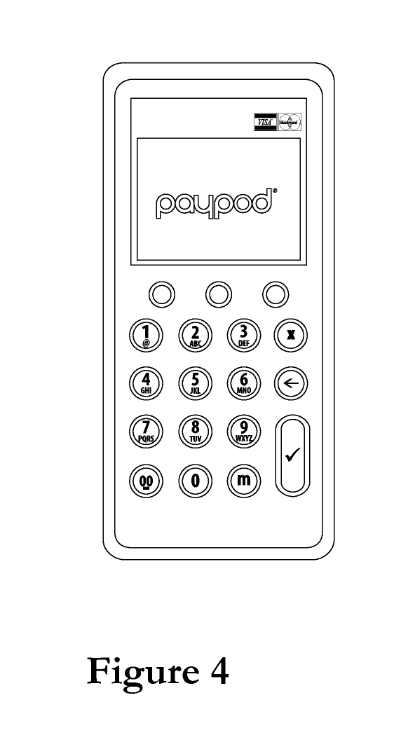

FIG. 4 is a frontal view of the PayPod card terminal of the present invention. The device includes a display, a keypad for inputting PIN numbers, payment amounts, and the like, and a card reader contact pad for accepting and connecting to a standard Smart Card. Referring to FIG. 1, the present invention detects wireless transmission of data from the card terminal from illicit transmitting equipment within the terminal in the form of a “shim” or otherwise. Included within the terminal electronics is a circuit designed to detect radiated signals over a wide range of frequencies. As illustrated in FIG. 1, this circuit comprises an antenna 810 in proximity to the card reader, preferably built-in to the card reader. An RF signal detector circuit 820 monitors for RF activity in the area around the card terminal. The RF signal detector circuit outputs an analog signal 850, which is fed to an analog input in the microprocessor 830 or other electronics.

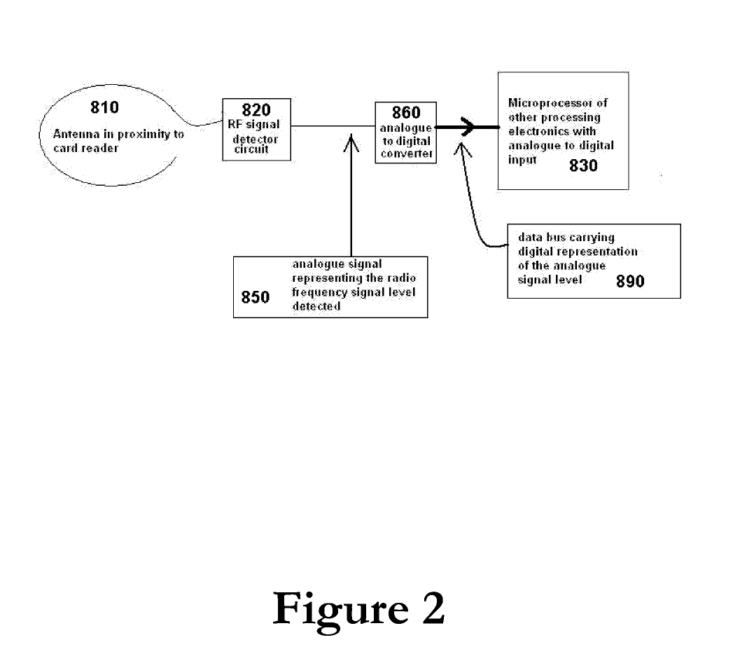

In the preferred embodiment of the invention, the RF signal detector circuit 820 is based around the LTC5507 RF Power detector chip from Linear Technology of Milpitas, California that operates over the range of frequencies from 100 kHz to 1 GHz. This particular circuit design provides an analog output voltage level that depends on the strength of the detected signal. Other circuit arrangements can provide similar functionality. In the present invention, the analog output 850 of the detector circuit 820 is connected to an A/D input of the 830 microprocessor as illustrated in FIG. 1. In this way, the voltage level at the input can be measured rather than just treating it as digital input where the voltage level would be taken by the processor as either ON (signal present) or OFF (signal not present).

Where the microprocessor (or other processing electronics) 830 used does not have an analog to digital converter input, an external analog to digital circuit 860 may be used as is illustrated in FIG. 2. In the embodiment of FIG. 2, an analog to digital converter 860 is coupled to the output of the RF signal detector circuit 820 and to a digital input of the microprocessor or other control circuitry 830. The microprocessor 830 may then monitor RF signal strength on the basis of the digital output 890 of the A/D converter 860 and take appropriate action to secure the device if suspicious levels of RF signals are detected, as previously described.

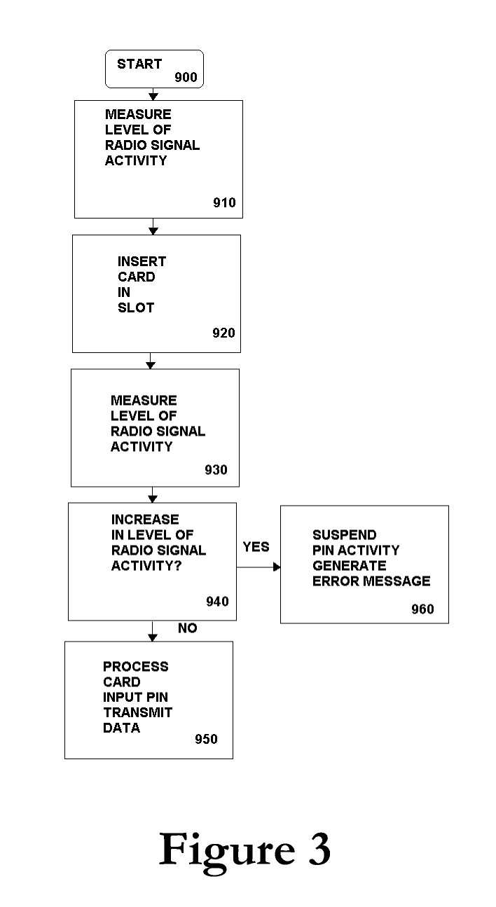

FIG. 3 is a flowchart illustrating the steps in the RF detection process of the present invention. The process starts at step 900. With the inclusion of the circuitry of FIG. 1 or 2, the terminal can determine the level of radio signal activity in its vicinity before a card is entered into the card slot as shown in step 910. In step 920, the card is inserted into the slot and the radio signal level after the card is inserted and the level during the time the terminal is exchanging data with the card is measured in step 930. If there is an abrupt increase in signal level when the card is inserted or when data exchange commences, as illustrated in step 940, the processor can ensure that the PIN is not sent to the card and can prevent all further transactions until the radio signal is no longer present as illustrated in step 960. An appropriate error message may be generated and displayed if unusual RF activity is detected. If no unusual RF activity is detected, the card reader may process the card data, accept PIN input, and process and transmit card and PIN data normally, as illustrated in step 950.

While disclosed herein in the context of a Credit Card and Payment terminal, the present invention may also be applied to any type of sensitive electronic device, where data protection and anti-tampering features are desirable. Such applications include, but are not limited to, Automated Teller Machines (ATMs), Cable and Satellite Television decoders (set-top boxes), Cellular telephones, Personal Digital Assistants, and the like.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A radio frequency detection system for a smart card reader, for detecting spurious and illicit radio frequency signals emanating from within or in the vicinity of a smart card reader, the radio frequency detection system comprising:
an antenna, mounted within or in proximity to the smart card reader;
a wideband radio frequency detection circuit, coupled to the antenna, for measuring radio frequency transmissions within the vicinity of the smart card reader and outputting an signal indicative of a level of radio frequency transmissions within the vicinity of the smart card reader; and
a processor, coupled to the wideband radio frequency detection circuit, for receiving the signal indicative of a level of radio frequency transmissions within the vicinity of the smart card reader, and determining whether radio frequency transmissions within the vicinity of the smart card reader are above a predetermined threshold.

2. The radio frequency detection system for a smart card reader of claim 1, further comprising:
an analog-to-digital converter, coupled between the wideband radio frequency detection circuit and the process, for converting the signal indicative of a level of radio frequency transmissions within the vicinity of the smart card reader to a digital signal indicative of a level of radio frequency transmissions within the vicinity of the smart card reader and passing the digital signal indicative of a level of radio frequency transmissions within the vicinity of the smart card reader to the processor.

3. The radio frequency detection system for a smart card reader of claim 1,
wherein the processor is programmed to determine a level of radio signal activity in the vicinity of the smart card reader before a smart card is inserted into the smart card reader,
wherein the processor is programmed to determine a level of radio signal activity in the vicinity of the smart card reader after the card is inserted into the smart card reader, and
if the processor determines an abrupt increase in radio frequency signal level is detected when the smart card is inserted into the smart card reader, the processor is programmed to disable further transactions until the radio signal is no longer present.

4. The radio frequency detection system for a smart card reader of claim 3, wherein the processor is programmed to output an error message if the processor determines an abrupt increase in radio frequency signal level is detected when the smart card is inserted into the smart card reader.

5. The radio frequency detection system for a smart card reader of claim 3, wherein the processor is programmed to suppress transmission of smart card data, including PIN number, the processor determines an abrupt increase in radio frequency signal level is detected when the smart card is inserted into the smart card reader.

6. The radio frequency detection system for a smart card reader of claim 1,
wherein the processor is programmed to determine a level of radio signal activity in the vicinity of the smart card reader before a smart card is inserted into the smart card reader,
wherein the processor is programmed to determine a level of radio signal activity in the vicinity of the smart card reader during a time the smart card reader is exchanging data with the card, and
if the processor determines an abrupt increase in radio frequency signal level is detected during a time the smart card reader is exchanging data with the card, the processor is programmed to disable further transactions until the radio signal is no longer present.

7. The radio frequency detection system for a smart card reader of claim 6, wherein the processor is programmed to output an error message if the processor determines an abrupt increase in radio frequency signal level is detected during a time the smart card reader is exchanging data with the card.

8. The radio frequency detection system for a smart card reader of claim 6, wherein the processor is programmed to suppress transmission of smart card data, including PIN number, the processor determines an abrupt increase in radio frequency signal level is detected during a time the smart card reader is exchanging data with the card.

9. A method of detecting spurious and illicit radio frequency signals emanating from within or in the vicinity of a smart card reader, comprising the steps of:
measuring, using a wideband radio frequency detection circuit, coupled to an antenna mounted within or in proximity to the smart card reader; frequency transmissions within the vicinity of the smart card reader,
outputting, from the wideband radio frequency detection circuit, a signal indicative of a level of radio frequency transmissions within the vicinity of the smart card reader; and
determining, in a processor coupled to the wideband radio frequency detection circuit and receiving the signal indicative of a level of radio frequency transmissions within the vicinity of the smart card reader, whether radio frequency transmissions within the vicinity of the smart card reader are above a predetermined threshold.

10. The method of detecting spurious and illicit radio frequency signals emanating from within or in the vicinity of a smart card reader in a smart card reader of claim 9, wherein the step of determining further comprises the steps of:
determining, in the processor, a level of radio signal activity in the vicinity of the smart card reader before a smart card is inserted into the smart card reader,
determining, in the processor, a level of radio signal activity in the vicinity of the smart card reader after the card is inserted into the smart card reader, and
if the processor determines an abrupt increase in radio frequency signal level is detected when the smart card is inserted into the smart card reader, disabling further transactions until the radio signal is no longer present.

11. The method of detecting spurious and illicit radio frequency signals emanating from within or in the vicinity of a smart card reader in a smart card reader of claim 10, wherein the step of determining further comprises the step of:
outputting from the processor, an error message if the processor determines an abrupt increase in radio frequency signal level is detected when the smart card is inserted into the smart card reader.

12. The method of detecting spurious and illicit radio frequency signals emanating from within or in the vicinity of a smart card reader in a smart card reader of claim 10, wherein the step of determining further comprises the step of:
suppressing, in the processor, transmission of smart card data, including PIN number, the processor determines an abrupt increase in radio frequency signal level is detected when the smart card is inserted into the smart card reader.

13. The method of detecting spurious and illicit radio frequency signals emanating from within or in the vicinity of a smart card reader in a smart card reader of claim 9, wherein the step of determining further comprises the steps of:
determining, in the processor, a level of radio signal activity in the vicinity of the smart card reader before a smart card is inserted into the smart card reader,
determining, in the processor, determine a level of radio signal activity in the vicinity of the smart card reader during a time the smart card reader is exchanging data with the card, and
if the processor determines an abrupt increase in radio frequency signal level is detected during a time the smart card reader is exchanging data with the card, disabling further transactions until the radio signal is no longer present.

14. The method of detecting spurious and illicit radio frequency signals emanating from within or in the vicinity of a smart card reader in a smart card reader of claim 13, wherein the step of determining further comprises the step of:
outputting an error message if the processor determines an abrupt increase in radio frequency signal level is detected during a time the smart card reader is exchanging data with the card.

15. The method of detecting spurious and illicit radio frequency signals emanating from within or in the vicinity of a smart card reader in a smart card reader of claim 13, wherein the step of determining further comprises the step of:
suppressing, in the processor, transmission of smart card data, including PIN number, the processor determines an abrupt increase in radio frequency signal level is detected during a time the smart card reader is exchanging data with the card.

16. A portable smart card reader terminal having a radio frequency detection system, for detecting spurious and illicit radio frequency signals emanating from within or in the vicinity of a smart card reader, the portable smart card reader terminal comprising:
a portable smart card reader terminal housing;
a keypad, mounted to the housing, for receiving input data from a user, including a PIN number;
a display, mounted to the housing, for displaying data;
an antenna, mounted within or in proximity to the smart card reader;
a wideband radio frequency detection circuit, coupled to the antenna, for measuring radio frequency transmissions within the vicinity of the smart card reader and outputting an signal indicative of a level of radio frequency transmissions within the vicinity of the smart card reader; and
a processor, coupled to the wideband radio frequency detection circuit, for receiving the signal indicative of a level of radio frequency transmissions within the vicinity of the smart card reader, and determining whether radio frequency transmissions within the vicinity of the smart card reader are above a predetermined threshold.

17. The portable smart card reader terminal having a radio frequency detection system of claim 16, further comprising:
an analog-to-digital converter, coupled between the wideband radio frequency detection circuit and the process, for converting the signal indicative of a level of radio frequency transmissions within the vicinity of the smart card reader to a digital signal indicative of a level of radio frequency transmissions within the vicinity of the smart card reader and passing the digital signal indicative of a level of radio frequency transmissions within the vicinity of the smart card reader to the processor.

18. The portable smart card reader terminal having a radio frequency detection system of claim 16,
wherein the processor is programmed to determine a level of radio signal activity in the vicinity of the smart card reader before a smart card is inserted into the smart card reader,
wherein the processor is programmed to determine a level of radio signal activity in the vicinity of the smart card reader after the card is inserted into the smart card reader, and
if the processor determines an abrupt increase in radio frequency signal level is detected when the smart card is inserted into the smart card reader, the processor is programmed to disable further transactions until the radio signal is no longer present.

19. The portable smart card reader terminal having a radio frequency detection system of claim 18, wherein the processor is programmed to output an error message if the processor determines an abrupt increase in radio frequency signal level is detected when the smart card is inserted into the smart card reader.

20. The portable smart card reader terminal having a radio frequency detection system of claim 18, wherein the processor is programmed to suppress transmission of smart card data, including PIN number, the processor determines an abrupt increase in radio frequency signal level is detected when the smart card is inserted into the smart card reader.

21. The portable smart card reader terminal having a radio frequency detection system of claim 16,
wherein the processor is programmed to determine a level of radio signal activity in the vicinity of the smart card reader before a smart card is inserted into the smart card reader,
wherein the processor is programmed to determine a level of radio signal activity in the vicinity of the smart card reader during a time the smart card reader is exchanging data with the card, and
if the processor determines an abrupt increase in radio frequency signal level is detected during a time the smart card reader is exchanging data with the card, the processor is programmed to disable further transactions until the radio signal is no longer present.

22. The portable smart card reader terminal having a radio frequency detection system of claim 21, wherein the processor is programmed to output an error message if the processor determines an abrupt increase in radio frequency signal level is detected during a time the smart card reader is exchanging data with the card.

23. The portable smart card reader terminal having a radio frequency detection system of claim 21, wherein the processor is programmed to suppress transmission of smart card data, including PIN number, the processor determines an abrupt increase in radio frequency signal level is detected during a time the smart card reader is exchanging data with the card.
